(19) United States
(12) Patent Application Publication
(10) Pub. No.: US 2010/0217681 A1
(43) Pub. Date: Aug. 26, 2010

(54) Shopping Cart Planogram Ordering System

(76) Inventors: James Geikie, Raleigh, NC (US); Jessica Brooks, Raleigh, NC (US); Mary Llewellyn Cox, Charlotte, NC (US); Ted Hein, Durham, NC (US); Amanda Sicvol, Durham, NC (US)

Correspondence Address: THE CLOROX COMPANY, P.O. BOX 24305, OAKLAND, CA, 94623-1305, US

(21) Appl. No.: 12/392,861

(22) Filed: Feb. 25, 2009

(51) Int. Cl. G06Q 30/00

(52) U.S. Cl. 705/26

(57) ABSTRACT

A method for providing remote ordering of products and configuring of individualized shelf configurations on a computer network, where the method comprises the steps of presenting an adjustable shelving plan having a shelving space; presenting a list of products or groups of products wherein each product or group of products has a cost; allowing a customer to adjust the shelving plan to reflect the customer's shelf space; allowing the customer to place products or groups of products on empty space in the shelving plan; showing the shelving plan with the products or groups of products placed on the shelving plan and showing the remaining empty space on the shelving plan; calculating the cost of the products or groups of products on the shelving plan; allowing the customer to order a set of products on the shelving plan; and receiving an order for the set of products on the shelving plan.

### BACKGROUND OF THE DISCLOSURE

1. Field of the Disclosure

The present invention relates to an online ordering and planogram tool which allows the retail or wholesale customer to design shelf layout, to track cost and to simplify ordering.

2. Description of Related Art

Retail stores are concerned with the placement of products on shelving areas. Retailers expend great time and effort in considering where and how to place products on the limited store shelves. The profitability of the store is in part dependent on an optimal placement of products for perusal by customers. If the customer cannot find a product, or a product does not catch his or her eye, or if there is insufficient stock on the shelf to meet demand, then a sale may be lost. Retailers are careful to place high-volume, high-profit-margin products in preferred locations, i.e., front of store, end of aisles, and eye-level shelves. With finite shelving area, each product must be allocated some number of facings to satisfy consumer demand, minimize shelf-stocking labor, and maximize visible exposure. A planogram is a product-placement layout, generated by a planning tool or computer program, which defines where products will be placed on the available store shelves, both in terms of shelf location and number of facings.

Large retail customers regularly use planograms to design optimal product placement on shelves. They then use ordering systems to ensure adequate product on shelf without excess inventory, for example as described in U.S. Pat. App. 2006/0190341 to Riley et al. U.S. Pat. No. 7,225,143 to Kepecs discloses consumer access to promotions via electronic commerce and potentially linking these promotions to a planogram of the store isle, so that the consumer can locate the promotions in a single pass through the store. Electronic commerce via shopping cart ordering is described in U.S. Pat. No. 7,110,968 to Haynes et al. and U.S. Pat. No. 6,249,773 to Allard et al.

Small retailers frequently lack sophisticated planogram tools, but require planograms that are flexible enough to handle small and irregular shelving blocks. These retailers often end up shelving products in a haphazard fashion not effectively using optimal merchandizing techniques. They also have relatively simple ordering systems to manage inventory. Small retailers have a need for a simple but flexible one-stop shelf planning tool combined with ordering to fill those shelf plans.

### SUMMARY OF THE DISCLOSURE

To answer the shortcomings of the prior art, the present invention provides in one embodiment a method for organizing shelving and managing an electronic commerce shopping cart relating to communication between a retail store and a server over a communication network, said method comprising the steps of adjusting a shelving plan on the server to correspond to a subset of shelf space within the retail store; having access to a list of products or groups of products wherein each product or group of products has a cost; placing the products or groups of products from the list of products on the subset of shelf space to show filled space and leftover space; showing the subset of shelf space with the selected items and the leftover space; showing the cost of the products or groups of products on the subset of shelf space; placing or removing additional products or groups of products from the list of products on the subset of shelf space to show new filled space and new leftover space; updating the cost corresponding to the items selected; allowing further modifications of the products or groups of products selected and the subset of shelf space; and allowing the retail store to purchase the selected items.

According to another embodiment, the present invention provides a method for providing remote ordering of products and configuring of individualized shelf configurations on a computer network, the method comprising the steps of: presenting an adjustable shelving plan having a shelving space; presenting a list of products or groups of products wherein each product or group of products has a cost; allowing a customer to adjust the shelving plan to reflect the customer's shelf space; allowing the customer to place products or groups of products on empty space in the shelving plan; showing the shelving plan with the products or groups of products placed on the shelving plan and showing the remaining empty space on the shelving plan; calculating the cost of the products or groups of products on the shelving plan; allowing the customer to order a set of products on the shelving plan; and receiving an order for the set of products on the shelving plan.

According to another embodiment, the present invention provides an automated method for allowing customers to order products and design a custom shelving plan, the method comprising the steps of: presenting a shelving plan having a shelving space; presenting a list of products or groups of products wherein each product or group of products has a cost; allowing the customer to place products or groups of products on empty space in the shelving plan; calculating the cost of the products or groups of products on the shelving plan; allowing the customer to order a set of products on the shelving plan; receiving an order for the set of products on the shelving plan; and allowing the customer to print out a visualized diagram of the shelving plan for accurate shelf stocking when the products arrive.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention. Together with the description, the drawings serve to explain various aspects of the invention.

### BRIEF DESCRIPTION OF THE DRAWINGS

For a more complete understanding of the present invention, the objects and advantages thereof, reference is now made to the following descriptions taken in connection with the accompanying drawings:

FIG. 1 is an exemplary image illustrating another portion of the planogram tool, according to one embodiment of the present invention.

FIG. 2 is an exemplary image illustrating a portion of the planogram tool, according to one embodiment of the present invention.

FIG. 3 is a flow diagram illustrating one embodiment of a process for implementing the planogram ordering process according to the present invention.

### DETAILED DESCRIPTION OF THE PREFERRED EMBODIMENTS

E-Commerce Website

The wholesale or retail customer uses a computer or other electronic communications device to connect to the on-line merchant through the Internet or other communications network. For example, the customer may have access, through formation of an account, to a secure B2B (business to business) website. On the website, the customer may order from a set of the merchant's products, or may use various tools, such as an on-line planogram to optimize a set of products to the customer's individualized shelf configuration.

Planogram Shelf Configuration Choices

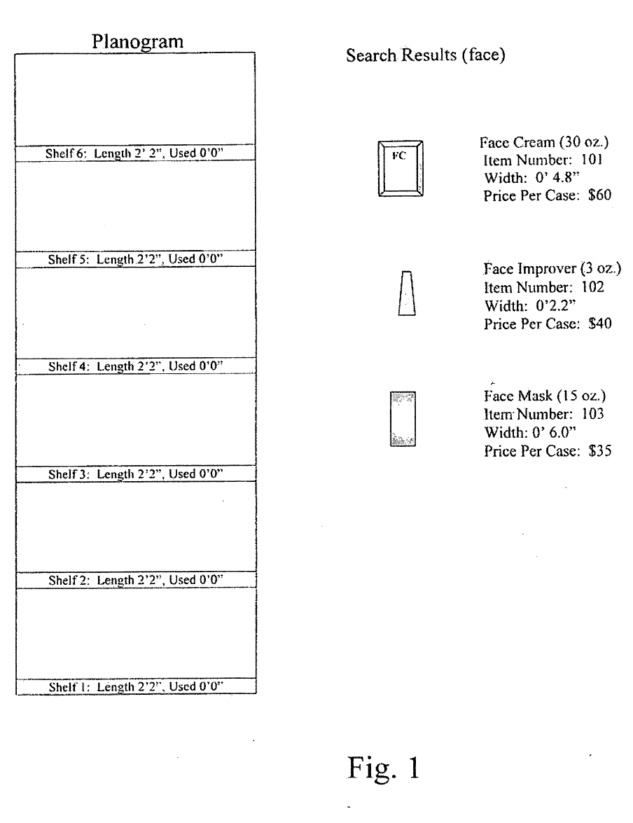

The wholesale or retail customer can start the planogram process by choosing an adjustable shelving plan having a shelving space, such as an empty shelf rack, for example a rack having 1 to 8 shelves, as shown in FIG. 1. The customer can adjust the shelving plan to reflect the customer's shelf space. Besides having a set number of shelves, the empty rack can have preconfigured shelf heights and shelf widths, and shelf depths. The customer can also choose to start with a preconfigured shelf rack containing suggested products and having 1 to 8 shelves and preconfigured according to store type, for example mainstream, grocery, specialty, or natural grocery (not shown). The customer can then modify the preconfigured shelving rack size or products or search for products to add to an empty shelving rack. The customer can also pull up his prior shelving plan for consideration or modification.

Search for Products

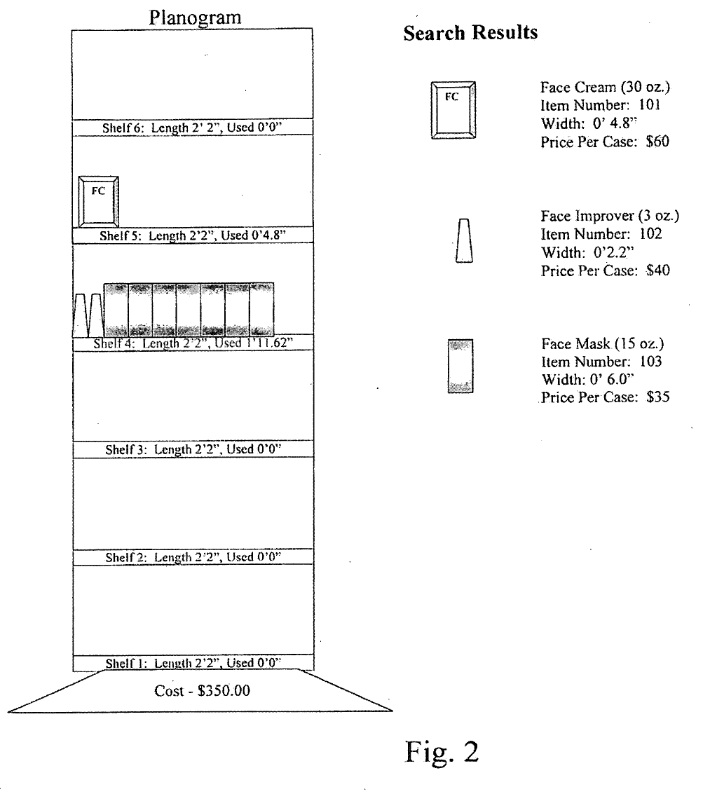

The customer can search for products or groups of products from a list in a variety of ways, for example by specific product name, by product category, by product item number, by product size (width or height). The customer then obtains a visual display of the products with associated cost resulting from that search, as shown in FIG. 1. The customer can place products or groups of products from the visual display by dragging and dropping (or use commands such as add item to shelf 1) one or more products from the search visual display onto empty space on the shelves of the shelf rack, as shown in FIG. 2. The shelving plan shows the remaining empty space on the shelves. The customer can perform another product search to generate another search visual display and place products from that search onto the shelves of the shelf rack and in this way the customer can sequentially choose multiple product lists and place products from these multiple product lists. As products are dropped onto various shelves, the shelf rack keeps track of the space left on the shelf and also rejects products that are too tall for the shelf or too wide to fit on the space left on the shelf. As products are dropped onto various shelves, the customer can also get a visual picture of how the products will look on the shelf at the customer's store. As the customer gets a visual picture of the shelves, the customer can remove items from the shelves or rearrange items on a shelf or between shelves. During the process of adding and rearranging products on the shelves, the total cost of the products on the shelves can be continuously calculated and updated, for example by showing the cost of one case or multiple cases of each product facing on the shelving rack, as shown at the bottom of the Planogram in FIG. 2. For example, the items are added and subtracted from an abstract on-line shopping cart.

To help the customer optimize the shelves for consumers, helpful hints can be provided with suggested primary and secondary shelf placement suggestions. These hints may also include a list of top selling products. After the customer has built the individualized planogram, the customer can separately download advertising materials for these products.

Remote Product Ordering

With the total cost of one case or multiple cases of each product facing on the shelving rack, the customer can order a set of products by one click confirmation of a purchase order for the products on the customer's individually designed shelving rack. The merchant receives the order corresponding to the set of products on the customer's shelving plan. The customer can also print out the visualized diagram of individualized shelving rack for accurate shelf stocking when the products arrive.

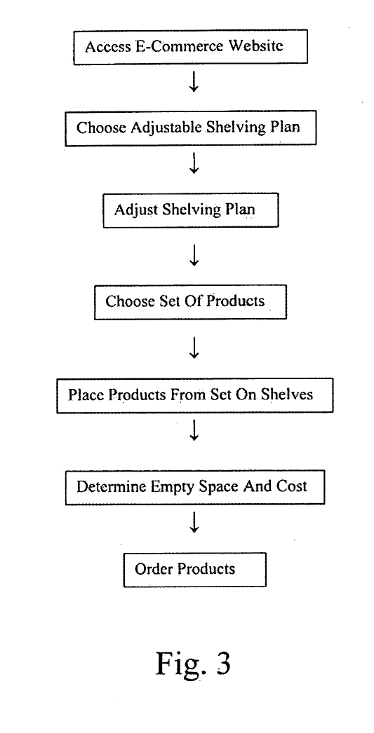

A flow diagram of the shopping cart planogram process is shown in FIG. 3. It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. (canceled)

2. The method of claim 21, wherein the shelving plan is the customer's prior shelving plan.

3. A method for providing remote ordering of products and configuring of individualized shelf configurations on a computer network, the method comprising the steps of:
a. providing a plurality of customers access to a website via a communication network;
b. presenting an adjustable shelving plan on said website, wherein said adjustable shelving plan has a shelving space;
c. presenting a list of products or groups of products wherein each product or group of products has a cost;
d. allowing a customer to adjust the shelving plan to reflect the customer's shelf space wherein said shelf space is not restricted;
e. allowing the customer to place products or groups of products on empty space in the shelving plan wherein the customer is not restricted to selecting a subset of products or groups of products;
f. showing the shelving plan with the products or groups of products placed on the shelving plan and showing the remaining empty space on the shelving plan;
g. calculating the cost of the products or groups of products on the shelving plan;
h. allowing the customer to order a set of products on the shelving plan; and
i. receiving the order for the set of products on the shelving plan via said communication network.

4. The method of claim 3, wherein the customer can search the product list by product category.

5. The method of claim 3, wherein the customer can search the product list by product size.

6. The method of claim 3, wherein the adjustable shelving plan includes a preconfigured shelving plan that can be modified to the customer's specifications.

7. The method of claim 3, wherein the adjustable shelving plan is the customer's prior shelving plan.

8. The method of claim 3, wherein the adjustable shelving plan is a preconfigured shelving plan.

9. The method of claim 8, wherein the preconfigured shelving plan corresponds to a store type.

10. The method of claim 3, wherein the customer can sequentially choose multiple product lists and place products from these multiple product lists.

11. The method of claim 3, wherein the customer can rearrange products between shelves.

12. The method of claim 3, wherein the customer is provided with shelf placement suggestions.

13. An automated method for allowing customers to order products from a merchant and design a custom shelving plan, the method comprising the steps of:
a. providing a plurality of customers access to a website via a communication network wherein said customers access the website with a computer or other electronic communications device;
b. presenting a shelving plan having a shelving space on said website;
c. presenting a list of products or groups of products wherein each product or group of products has a cost;
d. allowing the customer to place products or groups of products on empty space in the shelving plan wherein the merchant does not restrict the customer to selecting a specific subset of products or groups of products;
e. calculating the cost of the products or groups of products on the shelving plan;
f. allowing the customer to order a set of products on the shelving plan;
g. receiving the order for the set of products on the shelving plan via the communication network, and
h. allowing the customer to print out a visualized diagram of the shelving plan for accurate shelf stocking when the products arrive.

14. The method of claim 13, wherein the customer can search the product list by product category.

15. The method of claim 13, wherein the customer can search the product list by product size.

16. The method of claim 13, wherein the shelving plan includes a preconfigured shelving plan that can be modified.

17. The method of claim 13, wherein the shelving plan is the customer's prior shelving plan.

18. The method of claim 13, wherein the customer can sequentially choose multiple product lists and place products from these multiple product lists.

19. The method of claim 13, wherein the customer can rearrange products between shelves.

20. The method of claim 13, wherein the customer is provided with shelf placement suggestions.

21. A method for organizing shelving, said method comprising the steps of:
providing a customer using a computer or other electronic communications device access to a merchant's website through a communications network;
allowing the customer access the merchant's website;
allowing the customer to choose an adjustable shelving plan having a shelving space;
allowing the customer to adjust the shelving plan according to the customer's specifications wherein said specifications are not restricted by the merchant;
allowing the customer to place a plurality of products from a list of products or groups of products wherein each product or group of products has a cost onto the shelving plan to form a selected product list and wherein said list of products and groups of products are not restricted by the merchant and include all products the merchant has available for sale;
showing the customer the shelving plan with the selected product list and the cost of the selected product list;
allowing the customer to optionally, iteratively place or remove additional products or groups of products from the list of products to form a plurality of subsequent updated selected product lists;
optionally showing the customer the shelving plan with each subsequent updated selected product list and the cost of each subsequent updated selected product list; and
allowing the customer to purchase the selected items.
